(19) United States
(12) Patent Application Publication
(10) Pub. No.: US 2008/0299911 A1
(43) Pub. Date: Dec. 4, 2008

(54) METHOD AND APPARATUS FOR QUALITY OF SERVICE SIGNALING AND CONFIGURATION

(75) Inventors: John S. Chen, Ann Arbor, MI (US); Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/941,456

(22) Filed: Nov. 16, 2007

Related U.S. Application Data
(60) Provisional application No. 60/866,312, filed on Nov. 17, 2006.

(51) Int. Cl. H04B 17/00

(52) U.S. Cl. 455/67.13

(57) ABSTRACT

A method implemented in a wireless transmit receive unit (WTRU) for signaling Quality of Service (QoS) information. The method includes the WTRU transmitting a first scalar value indicative of a first plurality of QoS parameters, and the WTRU receiving a second scalar value indicative of a second plurality of QoS parameters

### CROSS REFERENCE TO RELATED APPLICATIONS

This application claims the benefit of U.S. provisional application No. 60/866,312 filed Nov. 17, 2006, which is incorporated by reference as if fully set forth.

### FIELD OF INVENTION

The invention relates to a wireless communication system. In particular a method and apparatus are disclosed for the use of Quality of Service (QoS) profile reference values in a wireless communication system.

### BACKGROUND

Performance of a communications channel or system is typically expressed as a Quality of Service (QoS) value. Depending upon the communication system, QoS may relate to service performance, Signal to Noise Ratio (SNR), Bit Error Ratio (BER), maximum and mean throughput rate, reliably, priority and other factors specific to each service. QoS in a Universal Mobile Telephone System (UMTS) is typically configured using an extensive set of attributes that are transmitted over an air interface. While the use of such attributes allows for flexibility in QoS configuration, it is inefficient and uses a significant amount of overhead in configuring QoS for a radio bearer.

A condensed reference value may be used for QoS. The value may be mapped to a profile of QoS attributes. However, methods to map reference values and methods to update a QoS profile are unclear. Furthermore, methods to handle QoS updates during inter-operator roaming are unclear, as each operator may have different QoS profiles and mappings.

### SUMMARY

A method and apparatus is disclosed for signaling QoS that includes a wireless transmit receive unit (WTRU) and a network exchanging scalar values indicative of a plurality of QoS parameters. The QoS parameters may be represented by indices and communicated between a plurality of WTRU's and a plurality of networks.

### BRIEF DESCRIPTION OF THE DRAWINGS

A more detailed understanding may be had from the following description, given by way of example and to be understood in conjunction with the accompanying drawings wherein:

FIG. 1 is a signaling diagram for a WTRU in an initial power-on state in accordance with one embodiment;

FIG. 2 is a signaling diagram for a WTRU with a QoS profile in accordance with another embodiment;

FIG. 3 is a signaling diagram for a WTRU receiving a QoS profile upgrade in accordance with an alternative embodiment;

FIG. 4 is a signaling diagram for a roaming WTRU in accordance with another alternative embodiment; and

FIG. 5 is a signaling diagram for a roaming WTRU in accordance with yet another alternative embodiment.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

A wireless communication system may include a plurality of wireless communication devices, such as a plurality of Node Bs, mobile stations, base stations and WTRUs, each capable of wirelessly communicating with one another. The wireless communication system may comprise any number and any combination of wireless devices. For example, the wireless communication system may include a Node B and a client device operating in an infrastructure mode, WTRUs operating in ad-hoc mode, nodes acting as wireless bridges, or any combination thereof.

A QosPackageID parameter may be included in a QoS profile to allow a WTRU to synchronize QoS parameters with a network operator during a wireless communication. The QosPackageID attaches a scalar value to a set of QoS profiles agreed upon between a specific operator and a specific WTRU. A QosPackageID may be used across the operator's network or between operators.

A QosServiceId parameter may also be included in a QoS profile. This parameter is a scalar value that indicates a service type, such as “voice” or “streaming video” and is a subset of the parameters represented by the QoSPackageID. Also, a QosProfileID parameter may be included in a Qos profile. This parameter is a scalar value that indicates a specific profile within a service type.

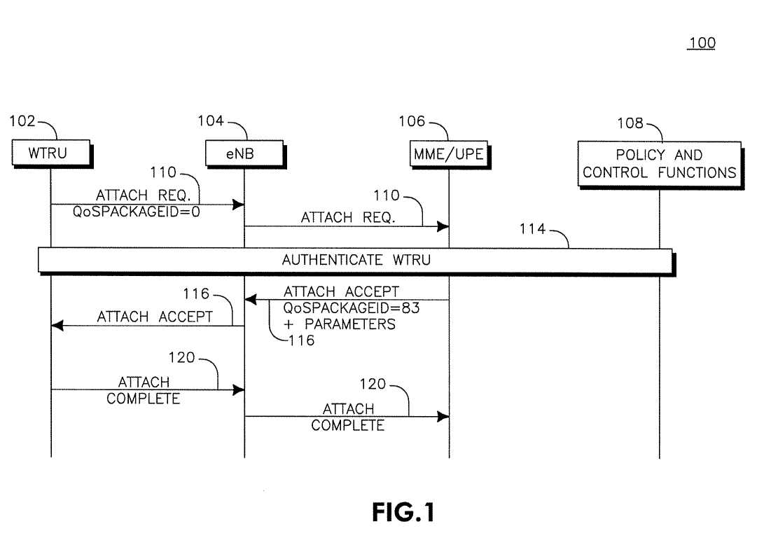

FIG. 1 shows a signaling diagram for a WTRU in an initial power-on state in accordance with one embodiment. A WTRU 102 has an account configured with QoS parameters as shown in Table 1.

TABLE 1
QoS Parameters

| | QoSServiceID | | | | |
|---|---|---|---|---|---|
| | 1 (streaming video) | | 2 (voice) | | 3 (background) |
| QoSProfileID | 1 | 2 | 1 | 2 | 1 |
| Max bitrate | 1 mbps | 500 kbps | 40 kbps | 30 kbps | 1 mbps |
| Guaranteed | — | — | 20 kbps | 12 kbps | — |
| bitrate | | | | | |
| Transfer Delay | — | — | 40 ms | 25 ms | — |
| (max) | | | | | |
| Residual BER | 10⁻³ | 10⁻⁴ | 10⁻⁴ | 10⁻³ | 10⁻³ |

As shown in Table 1, the QoS parameters may be represented by a QoSService ID, which is a scalar value representing a service. QoSServiceID=1 represents streaming video, QoSServiceID=2 represents voice, and QoSService ID=3 represents background. Each service can be sub-divided into one or more QoSProfileIDs, each representing a specific profile within a service. As shown in Table 1, QoSServiceID=1, QoSProfileID=1 represents streaming video service with a maximum bit rate of 1 mpbs, and a residual bit error rate (BER) of 10⁻³. QoSServiceID=1, QoSProfileID=2 represents streaming video service with a maximum bit rate of 500 kps and a BER of 10-4. QoSServiceID=2, QoSProfileID=1 represents a voice service with maximum bit rate of 40 kps, a guaranteed bit rate of 20 kps, a maximum transfer delay of 40 ms and a residual BER of 10-4.

Turning now to FIG. 1, the WTRU 102 sends an Attach Request 110 to an eNB 104 with the variable QosPackageID=0. This is a null version ID that signifies that the WTRU 102 does not have stored QoS profiles corresponding to any QosPackageID. The eNB 104 forwards the Attach Request 110 to a mobility management entity/user plane entity (MME/UPE) 106. The WTRU 102 is authenticated 114, and the MME/UPE obtains the QosPackageID that the WTRU 102 uses. An Attach Accept message 116, including a QosPackageID and QoS parameters, is sent from the MME/UPE 106 to the eNB 104 with the QosPackageID and QoS profiles similar to those shown in Table 1. The WTRU 102 receives the Attach Accept message 116 with all of the QoS profiles. The WTRU 102 sends the Attach Complete message 120 to the eNB 104, which then forwards the Attach Complete 120 message to the MME/UPE 106.

Having performed this configuration process, the WTRU 102 and the network 108 can communicate the predefined QoS profile via the QosServiceID and QosProfileID. For instance, referring to Table 1, if a user is running a streaming download application at 384 kbps, it may request the 500 kbps streaming video profile by sending the network QosServiceID=1, QosProfileID=2.

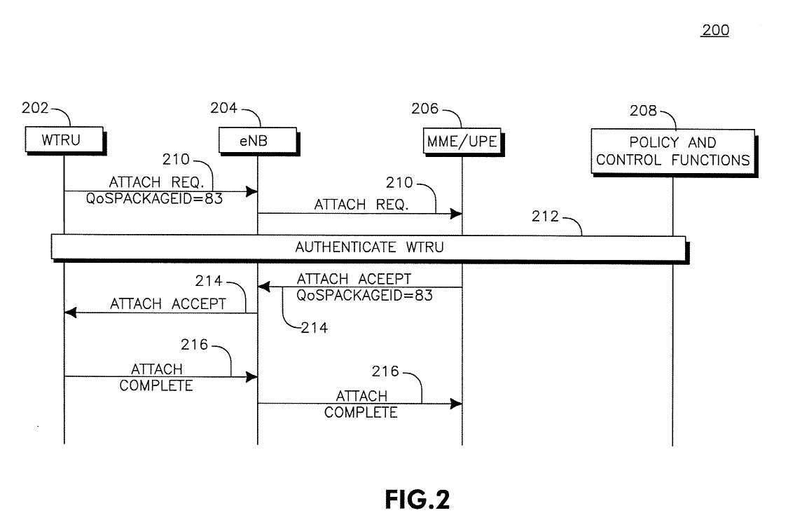

FIG. 2 is a signaling diagram for a WTRU with a QoS profile in accordance with another embodiment. A WTRU 202 sends an attach request 210 to an eNB 204. The attach request 210 includes a QosPackageID. The eNB 204 forwards the attach request 210 to a MME/UPE 206 and the WTRU 202 is authenticated 212. Once the WTRU 202 is authenticated, the MME/UPE 206 sends an Attach Accept message 214 to the eNB 204. The Attach Accept message 214 includes the QoSPackageID transmitted in the Attache Request message 210. The eNB 204 forwards the Attach Accept message 214 to the WTRU 202. The WTRU 202 then sends an Attach Complete message 216 to the eNB 204. The message is forwarded to the MME/UPE 206. In general, the network echoes the QosPackageID in the Attach Accept message 214.

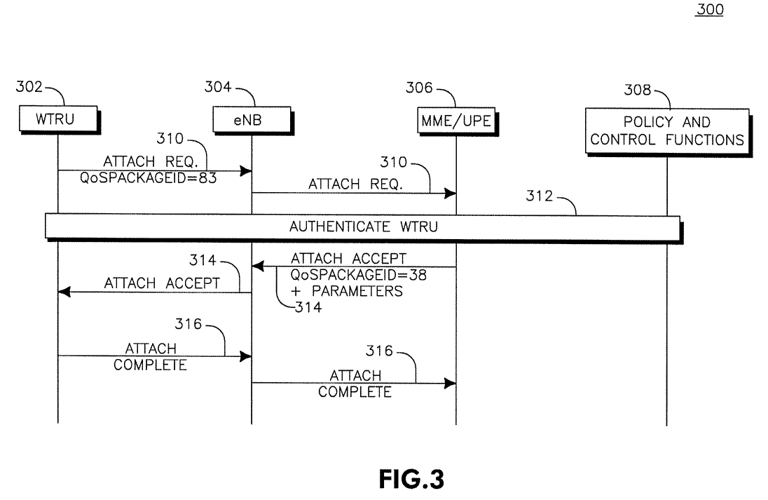

FIG. 3 shows a signaling diagram for a QoS profile upgrade. The WTRU 302 may, for example, upgrade to a higher streaming video speed. The account for the WTRU may be revised, as shown in Table 2. Referring to FIG. 3, a WTRU 302 sends an Attach Request 310 to an eNB 304. The attach request 310 includes the current QosPackageID. The eNB 304 forwards Attach Request 310 to the MME/UPE 306. The WTRU 302 is authenticated 312, and the MME/UPE 306 obtains the new QosPackageID that the WTRU 302 will use. The Attach Accept message 314 is sent from the MME/UPE 306 to the eNB 304 with the new QosPackageID and differential QoS profiles. Referring to Table 2, in order to upgrade to 2 mps streaming video, the message may indicate that (QosServiceID, QosProfileID)=(1, 2) is deleted, and it will add (QosServiceID, QosProfileID)=(1, 3). As shown in Table 2, QoSServiceID=1, QoSProfileID=3 represents streaming video with a maximum bit rate of 2 mps and a residual BER of 10⁻³. Referring again to FIG. 3, the WTRU 302 receives the Attach Accept message 314 with the new QosPackageID and a new QoS profile. The entire profile need not be transmitted. The new profile may be transmitted differentially, such that only the difference between the profile as shown in Table 1 and the profile shown in Table 2 is transmitted. The WTRU 302 then sends the Attach Complete message 316.

TABLE 2
QoS Parameter upgrade

| | QosServiceID | | | | |
|---|---|---|---|---|---|
| | 1 (streaming video) | | 2 (voice) | | 3 (background) |
| QosProfileID | 1 | 3 | 1 | 2 | 1 |
| Max bitrate | 1 mbps | 2 mbps | 40 kbps | 30 kbps | 1 mbps |
| Guaranteed | — | — | 20 kbps | 12 kbps | — |
| bitrate | | | | | |
| Transfer | — | — | 40 ms | 25 ms | — |
| Delay (max) | | | | | |
| Residual | 10⁻³ | 10⁻³ | 10⁻⁴ | 10⁻³ | 10⁻³ |
| BER | | | | | |

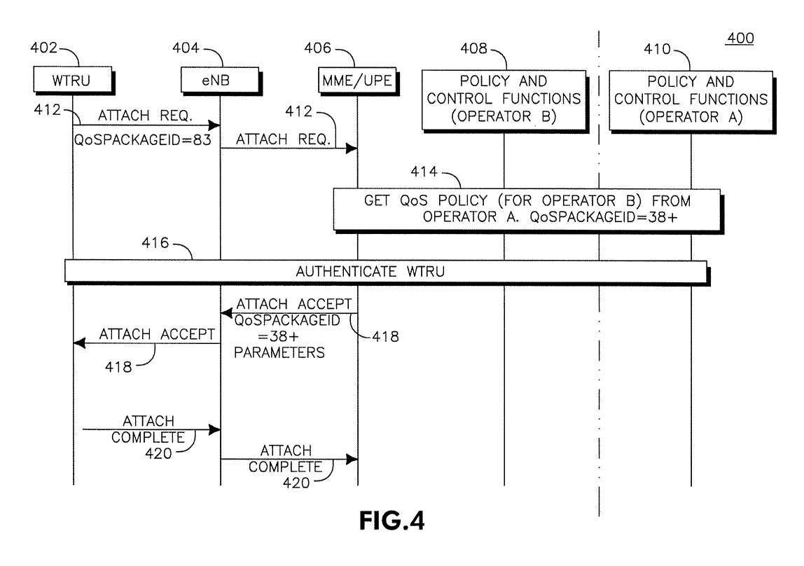

FIG. 4 shows a signaling diagram for a roaming WTRU in accordance with another alternative embodiment. A WTRU 402 gets a new profile from the operator of a roaming network 410. The WTRU 402 sends an Attach Request 412 to an eNB 404 with the WTRU's home network QosPackageID. The eNB 404 forwards the Attach Request 412 to the MME/UPE 406. Operator B 408 communicates with operator A 410 to exchange QoS policy for this user. As a result, operator B 408 assigns a set of QoS profiles and a QosPackageID 414 in its own network. This policy exchange may be performed, for example, through a service level agreement (SLA) between network A 410 and network B 408.

The WTRU 402 is authenticated through its home network 416. The Attach Accept message 418 is sent from the MME/UPE 406 to the eNB 404 with the QosPackageID from operator B 408 and QoS profiles. Optionally, operator B 408 may send the QoS profiles differentially relative to the profile from operator A 410. By way of further example, if operator B 408 supports the QoS profiles from operator A 410 for the WTRU 402 without modification, it may send a differential QoS profile (relative to the QosPackageID from operator A) indicating no changes.

The WTRU 402 receives the Attach Accept message 418 with the QosPackageID and QoS profiles. The WTRU 402 then sends the Attach Complete message 420.

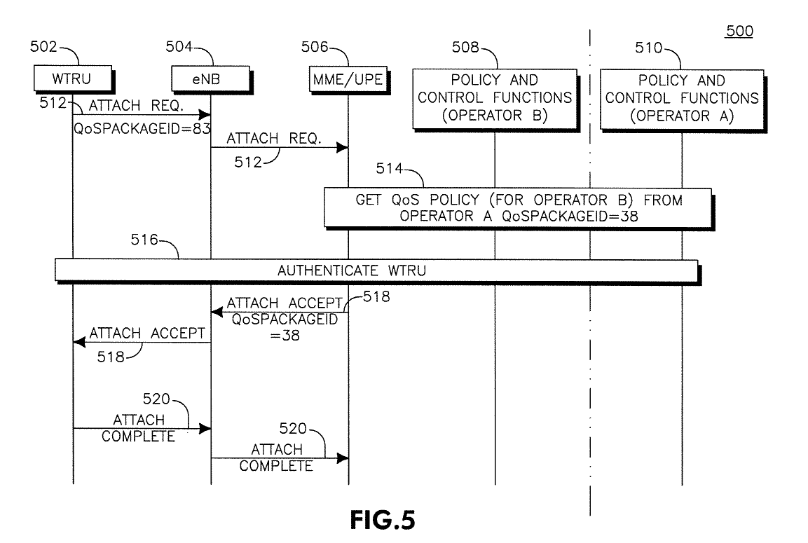

FIG. 5 shows a signaling diagram for a WTRU in a roaming environment in accordance with yet another alternative embodiment. It would be inefficient for the WTRU 502 to receive a new QoSPackageID every time the WTRU 502 attaches to operator B 508. In order to prevent this from occurring, the WTRU 502 may store the last configuration it was sent from its most recent attachment to operator B 508. As shown in FIG. 5, the WTRU 502 sends an Attach Request 512 to an eNB 504 with a QosPackageID in the roaming network. The eNB 504 forwards Attach Request 512 to the MME/UPE 506. Operator B 508 receives a message 514 with the QoS policy from operator A 510 for the user. Operator B 508 assigns a set of QoS profiles, and QosPackageID in its network. This policy exchange may, for example, be done through a service level agreement (SLA) between operator A 510 and operator B 508. The WTRU 502 is authenticated 516 through its home network. The Attach Accept message 518 is sent from the MME/UPE 506 to the eNB 502 with the QosPackageID from operator B 508. The WTRU 502 knows the associated QoS profiles, so there is no need to send them. If the package ID has changed, the MME/UPE 506 may also send a differential profile analogous to that shown in FIG. 3. The eNB 504 forwards the Attach Accept message 518 the WTRU 502. The WTRU 502 receives the Attach Accept message 518 with the QosPackageID. The WTRU 502 sends the Attach Complete message 520 to the eNB 504. The eNB 504 forwards the Attach Complete message 520 to the MME/UPE 506.

Although the features and elements are described in the embodiments in particular combinations, each feature or element can be used alone without the other features and elements of the embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method implemented in a wireless transmit receive unit (WTRU) for signaling Quality of Service (QoS) information, the method comprising::
transmitting a first scalar value indicative of a first plurality of QoS parameters; and
receiving a second scalar value indicative of a second plurality of QoS parameters

2. The method as in claim 1 further comprising the WTRU:
transmitting a first scalar values indicative of a subset of the first plurality of QoS parameters; and
the WTRU receiving a second scalar value indicative of a subset of the second plurality of QoS parameters.

3. The method as in claim 2 wherein the subset of QoS parameters comprises a service type.

4. The method as in claim 1 wherein the plurality of QoS parameters comprises a maximum bit rate, a guaranteed bit rate, a maximum transfer delay and a residual bit error rate.

5. The method as in claim 1 further comprising setting the scalar values to zero (0) at a WTRU start-up.

6. The method as in claim 1 wherein the first plurality of QoS parameters and the second plurality of QoS parameters are the same.

7. The method as in claim 1 further comprising:
the WTRU signaling the scalar value indicative of the first plurality of QoS parameters; and
the WTRU receiving a confirmation message confirming the scalar value.

8. The method as in claim 1 further comprising:
the WTRU signaling a scalar value indicative of a subset of the first plurality of QoS parameters; and
the WTRU receiving a confirmation message confirming the scalar value.

9. The method as in claim 1 further comprising:
the WTRU signaling a scalar value indicative of the first plurality of QoS parameters;
the WTRU receiving a confirmation message confirming the scalar value.

10. The method as in claim 9 further comprising the second network receiving the first plurality of QoS parameter from the first network.

11. The method as in claim 1 further comprising:
the WTRU signaling a scalar value indicative of a subset of the plurality of QoS parameters to a first network;
the WTRU receiving a confirming message confirming the scalar value.

12. A method of quality of service (QoS) signaling comprising:
a wireless transmit receive unit (WTRU) transmitting an attach request, wherein the attach request comprises a scalar value indicative of a plurality of QoS parameters; and
the WTRU receiving an attach accept message, wherein the attach accept message comprises the scalar value indicative of the plurality of QoS parameters and a plurality of QoS parameters.

13. The method as in claim 12 further comprising the WTRU transmitting a null request on start-up.

14. The method as in claim 12 further comprising:
the WTRU transmitting a first scalar value indicative of a first plurality of QoS parameters in an attach request message; and
the WTRU receiving a second scalar value indicative of a second plurality of QoS parameters in an attach accept message.

15. The method as in claim 14 further comprising:
the WTRU transmitting the first scalar value; and
the WTRU receiving the second scalar value, wherein the second scalar value indicates a handover network.

16. A wireless transmit receive unit (WTRU) comprising:
a receiver configured to receive a scalar value indicative of a plurality of quality of service (QoS) parameters; and
a processor coupled to the receiver and configured to apply the plurality of QoS parameters indicated by the scalar value.

17. The WTRU as in claim 16 wherein the WTRU further comprises:
a receiver configured to receive a scalar value indicative of a subset of the plurality of QoS parameters; and
a processor coupled to the receiver and configured to apply the subset of the plurality of QoS parameters indicated by the scalar value.

18. The WTRU as in claim 16 wherein the receiver is further configured to receive the plurality of QoS parameters.

19. The WTRU as in claim 16 further comprising:
a transmitter configured to transmit a first scalar value indicative of a first plurality of QoS parameters, and
a receiver configured to receiver a second scalar value indicative of a second plurality of QoS parameters.

20. The WTRU as in claim 19 wherein the receiver is further configured to receive the plurality of QoS parameters.

21. The WTRU as in claim 19 wherein the receiver is further configured to receive a differential set of QOS parameters, wherein the differential set of QoS parameters is a difference between the first plurality of QoS parameters and the second plurality of QoS parameters.
